(19) United States
(12) Patent Application Publication
(10) Pub. No.: US 2021/0092533 A1
(43) Pub. Date: Mar. 25, 2021

(54) FILTER GENERATION METHOD, SOUND PICKUP DEVICE, AND FILTER GENERATION DEVICE

(71) Applicant: JVCKENWOOD CORPORATION, Yokohama-shi (JP)

(72) Inventors: Hisako MURATA, Kanagawa (JP); Toshiaki NAGAI, Kanagawa (JP)

(73) Assignee: JVCKENWOOD Corporation

(21) Appl. No.: 17/001,331

(22) Filed: Aug. 24, 2020

(30) Foreign Application Priority Data
Sep. 24, 2019 (JP) 2019-173013

(51) Int. Cl. H04R 25/00

(52) U.S. Cl. CPC H04R 25/48

(57) ABSTRACT

A method of generating a filter according to an embodiment includes producing a shaped object to correspond to a user's ear canal using an impression material, producing the user's ear impression based on the shaped object, installing a microphone in an ear canal part penetrating to an inner ear side of the ear impression, installing an earphone or a headphone in the ear impression, measuring transfer characteristics by the microphone collecting a measurement signal output from the earphone or the headphone, and generating a filter based on the transfer characteristics.

### CROSS REFERENCE TO RELATED APPLICATION

This application is based upon and claims the benefit of priority from Japanese patent application No. 2019-173013, filed on Sep. 24, 2019, the disclosure of which is incorporated herein in its entirety by reference.

### BACKGROUND

The present disclosure relates to a filter generation method, a sound pickup device, and a filter generation device.

Sound localization techniques include an out-of-head localization technique, which localizes sound images outside the head of a listener by using headphones. In the out-of-head localization technique, characteristics from the headphones to the ears are cancelled out, and four characteristics (spatial acoustic transfer characteristics) from the stereo speaker to the ears are provided to locate the sound images outside the head.

In out-of-head localization reproduction, microphones placed in listener's ears record measurement signals (impulse sounds, etc.) emitted from a 2-channel (hereinafter referred to as ch.) speaker. Then, a processing device creates a filter based on a sound pickup signal obtained by an impulse response. The created filter is convolved into a 2ch audio signal to achieve the out-of-head localization reproduction.

Furthermore, in order to generate a filter for canceling out the characteristics from the headphone to the ear, the characteristics from the headphones to the ears or the eardrums (ear canal transfer function ECTF, also called ear canal transfer characteristics) are measured by microphones placed in the listener's ears.

WO2016/063462 discloses the use of a custom earphone having a shape fitting the shape of a user's ear. WO2016/063462 also discloses providing a noise collecting microphone in a housing.

In order to perform out-of-head localization processing, it is preferable to measure individual characteristics in terms of both spatial acoustic transfer characteristics and ear canal transfer characteristics. However, it is difficult for a user to wear a microphone while wearing headphones or earphones. Thus, there is a problem that it is difficult to appropriately collect sounds and create a filter.

### SUMMARY

An example aspect is a method of generating a filter including: producing a shaped object to correspond to a user's ear canal using an impression material; producing the user's ear impression based on the shaped object; installing a microphone in an ear canal part penetrating to an inner ear side of the ear impression; installing an earphone or a headphone in the ear impression;

measuring transfer characteristics by the microphone collecting a measurement signal output from the earphone or the headphone; and generating a filter based on the transfer characteristics.

Another example aspect is a sound pickup device including: an ear impression produced to correspond to a shape of a user's ear; and a microphone installed in an ear canal part penetrating the ear impression.

According to the present disclosure, it is possible to provide a sound pickup device, a filter generation device, and a filter generation method that can appropriately collect sounds.

### BRIEF DESCRIPTION OF THE DRAWINGS

The above and other aspects, advantages and features will be more apparent from the following description of certain embodiments taken in conjunction with the accompanying drawings, in which:

FIG. 1 is a flowchart showing a filter generation method according to an embodiment;

FIG. 2 shows a shaped object produced from an impression material;

FIG. 3 shows a shaped object produced from an impression material;

FIG. 4 shows a user's ear impression;

FIG. 5 is a schematic view showing an ear impression before a through hole is formed;

FIG. 6 is a schematic view showing an ear impression in which a microphone is installed;

FIG. 7 is a schematic view showing a modified example of an ear impression in which a microphone is installed;

FIG. 8 schematically shows a configuration of a filter generation device;

FIG. 9 schematically shows a sound pickup device according to a second embodiment;

FIG. 10 schematically shows the sound pickup device according to the second embodiment; and

FIG. 11 is a diagram for explaining a method of positioning a first impression and a second impression.

### DETAILED DESCRIPTION

A sound pickup device according to this embodiment performs measurement for generating a filter to be used in out-of-head localization. The overview of out-of-head localization is described hereinafter. The out-of-head localization process performs out-of-head localization by using personal spatial acoustic transfer characteristics (which are also called a spatial acoustic transfer function) and ear canal transfer characteristics (which are also called an ear canal transfer function). In this embodiment, out-of-head localization is achieved by using the spatial acoustic transfer characteristics from speakers to ears and the ear canal transfer characteristics when earphones (or headphones) are worn.

In the out-of-head localization processing, the ear canal transfer characteristics, which are characteristics from an earphone speaker unit to the entrance of the ear canal when earphones are worn, are used. By carrying out convolution with use of the inverse characteristics of the ear canal transfer characteristics (which are also called an ear canal correction function), it is possible to cancel out the ear canal transfer characteristics. Thus, a microphone for measuring the ear canal transfer characteristics is used. That is, the measurement is carried out using microphones and earphones.

The user's ear impression is used to measure the ear canal transfer characteristics. That is, the microphone is placed in an ear impression resembled to the shape of the user's ear, so that a sound pickup device for generating a filter is formed. Further, an earphone is attached to the ear impression. The microphone picks up an impulse response when impulse sounds from the earphones are output. It is thereby possible to measure the ear canal transfer characteristics from the earphones to the ear or eardrum. Note that the microphone may be placed at any position corresponding to a position between the ear and the eardrum. The range of the ear is a range including the entrance of the ear canal.

### First Embodiment

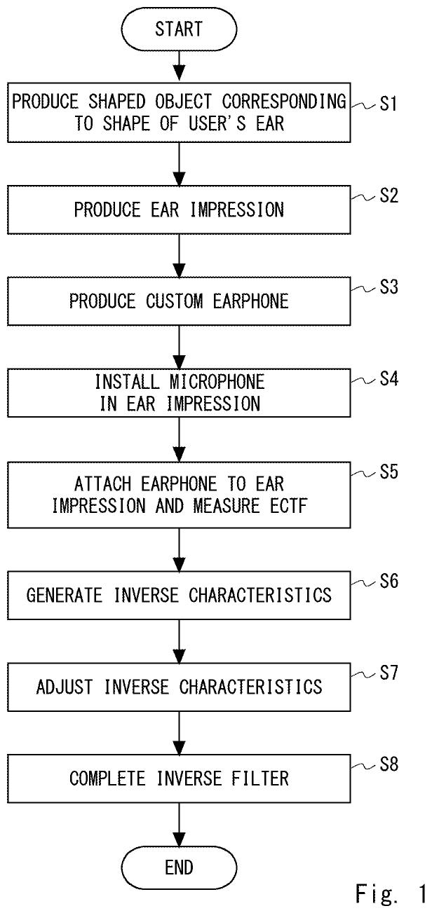

A filter generation method according to a first embodiment will be described with reference to FIG. 1. FIG. 1 is a flowchart showing the filter generation method.

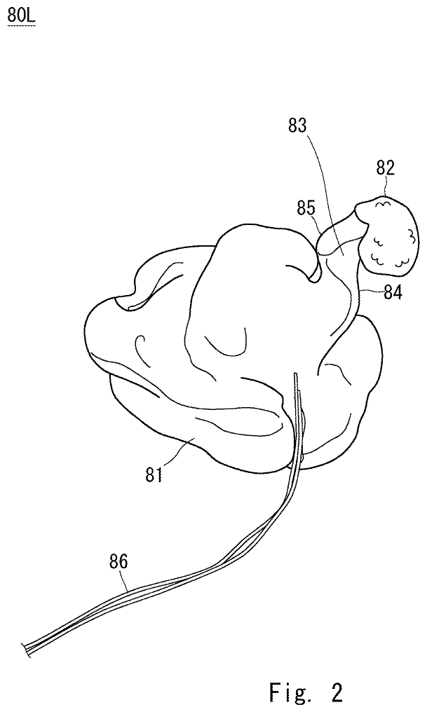

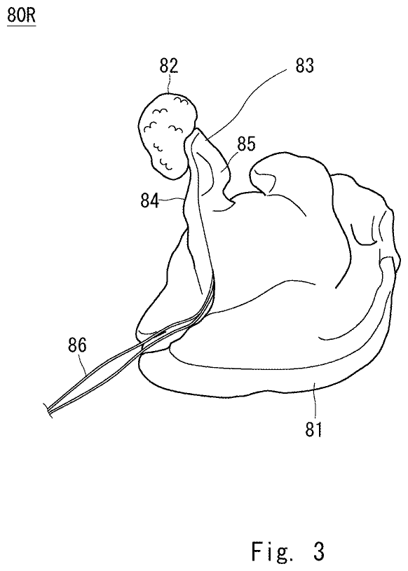

First, a shaped object corresponding to the shape of the user's ear is created (S1). FIGS. 2 and 3 are diagrams schematically showing produced shaped objects. FIG. 2 shows an example of a shaped object 80L of the left ear, and FIG. 3 shows an example of a shaped object 80R of the right ear. A procedure for producing the shaped objects 80L and 80R will be described.

A stopper 82 is inserted into the user's ear canal. Absorbent cotton or sponge may be used as the stopper 82. The stopper 82 is inserted, for example, at a position 1 to 2 mm inner side of a second curve of the ear canal. A first curve is a curve positioned nearest to the entrance in the ear canal, and the second curve is a curve appearing after the first curve.

Threads 86 are attached to the stopper 82. This prevents the stopper 82 from being inserted deep into the ear canal. A form is placed around the outer ear. As the form, for example, a core (a cylinder made of paper) of packing tape, a pipe made of resin or metal may be used.

Then, an impression material 81 is injected into the ear canal (ear hole). Specifically, the impression material 81 is injected into the ear canal using, for example, a syringe. As the impression material 81, for example, silicone rubber and ultra-soft urethane resin may be used. The impression material 81 is injected into the ear canal until it reaches the stopper 82. The impression material 81 is cured after 5 to 10 minutes from when the impression material 81 is injected. The cured impression material 81 is taken out from the ear canal together with the stopper 82. For example, the impression material 81 can be removed by pulling the threads 86. By pulling the threads 86 together with the form placed to surround the outer ear, the impression material 81 can be removed safely. In this way, the shaped objects 80L and 80R as shown in FIGS. 2 and 3 can be obtained.

The shaped objects 80L and 80R are inverted impressions of ear impressions and have a shape obtained by transferring the user's ear canal. Thus, the shaped objects 80L and 80R each have an ear canal part 83, a first curve part 84, and a second curve part 85. The ear canal part 83 is a projection extending toward the inner ear side along the shape of the ear canal. The stopper 82 is provided at the leading end of the ear canal part 83.

The impression material 81 is injected deeper than the second curve of the ear canal. The first curve part 84 corresponding to the first curve of the ear canal and the second curve part 85 corresponding to the second curve of the ear canal can be formed in the ear canal part 83. The first curve part 84 and the second curve part 85 are provided midway through the ear canal part 83. Since the detailed procedure of obtaining an ear impression is described in U.S. Pat. No. 5,487,012, a detailed description thereof is omitted.

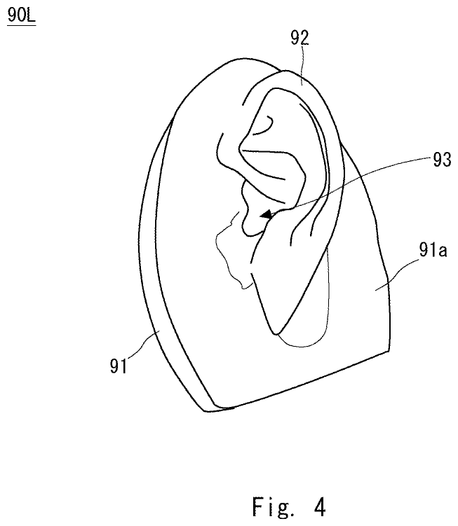

Next, the user's ear impression is produced based on the shaped objects 80L and 80R (S2). FIG. 4 shows an example of the produced left ear impression 90L. The shaped object 80L is an inverted impression of the ear impression 90L. The shaped object 80L is accommodated in a case, and a resin material is poured into the case. After the resin material is cured, the shaped object 80L is removed to complete the ear impression 90L. A right ear impression can be produced in a similar manner by using the shaped object 80R, as a matter of course. The filter for the left ear and the filter for the right ear can be generated in the similar steps, and thus the following description will focus on the generation of the filter for the left ear.

As the resin material, for example, a photopolymer (photo-curable resin) such as an ultraviolet curing resin (UV resin) may be used. The resin material is not limited to photo-curable resins, and other resin materials such as thermosetting resin and ultra-soft urethane resin may be used. In place of the resin material, various silicone rubber materials which are hard to adhere to the impression material may be used. The present disclosure is not limited to these materials, and instead other materials having softness or a surface shape close to those of the skin of a human body may be used. The resin material of the ear impression 90L may differ from the resin material of the shaped object 80L.

Alternatively, a 3D printer may be used to create the ear impression 90L. For example, a three-dimensional shape of the shaped object 80L is measured using a three-dimensional shape measuring instrument. CAD (Computer Aided Design) data of the ear impression 90L is prepared based on measurement data of the three-dimensional shape of the shaped object 80L. This CAD data is input to the 3D printer, so that the 3D printer forms the ear impression 90L.

The ear impression 90L includes a base part 91, an auricle part 92, and an ear canal part 93. The auricle part 92 has a shape resembled to the user's auricle. In FIG. 4, the auricle part 92 corresponds to the user's entire auricle. Alternatively, the auricle part 92 may correspond to only a part of the user's auricle. When an earphone using an ECTF from the ear canal to the eardrum such as a custom earphone or a canal type earphone is used, the ear impression 90L only needs to have a shape of the entrance of ear canal and its periphery, and a part corresponding to the ear ring, earlobe, etc., may be omitted.

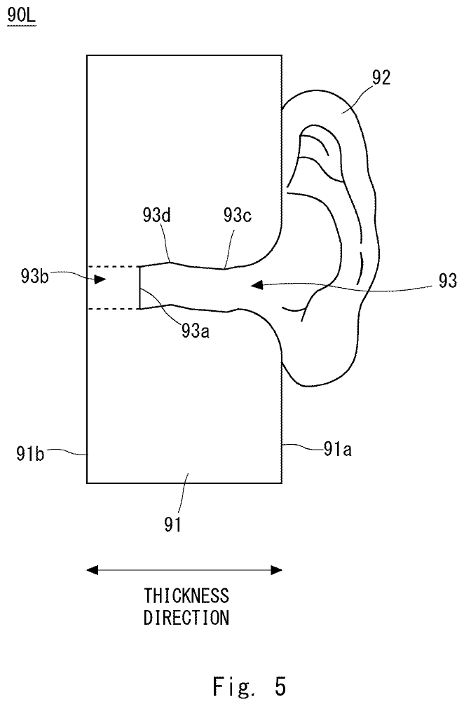

The base part 91 is a flat part on the root side of the auricle part 92. The base part 91 serves as a base of the auricle part 92. In the base part 91, the plane on the side where the auricle part 92 is provided is a front surface 91a, and the opposite side is a back surface 91b (see FIG. 5, etc.). The back surface 91b side of the base part 91 is the inner ear side. The thickness of the base part 91 is preferably 4 cm or more. Note that the thickness of the base part 91 is a length from the front surface 91a to the back surface 91b. The thickness direction is a direction along a direction in which the ear canal part 93 extends.

The ear canal part 93 corresponds to the user's ear canal. Thus, the ear canal part 93 has a shape corresponding to the ear canal part 93 of the shaped object 80L. To be more specific, the ear canal part 93 is a hole provided in the base part 91. The ear canal part 83 of the shaped object 80L has the first curve part 84 and the second curve part 85. Therefore, the ear canal part 93 of the ear impression 90L is a hole resembled to the shape of the user's ear from the position of the entrance of the user's ear canal to the position father than the second curve of the ear canal. The ear canal part 93 may be a through hole penetrating the base part 91 or may be a recess provided midway in the thickness direction of the base part 91.

Next, a custom earphone is produced using the ear impression 90L (S3). The custom earphone has a shape fitting to the user's ear. Since a known technique can be used to produce a custom earphone, description thereof is omitted.

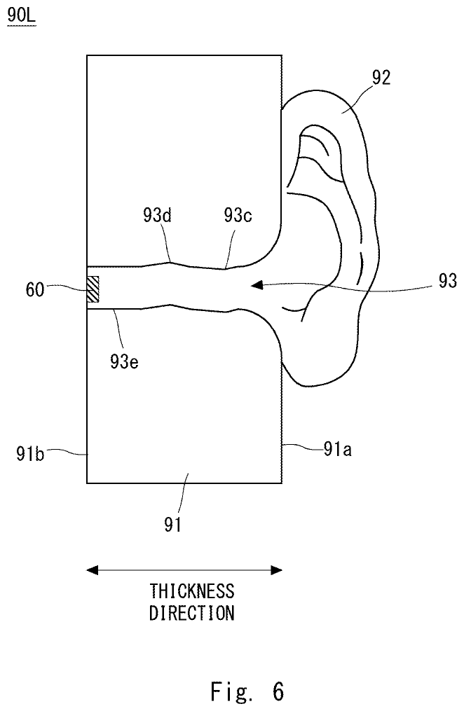

A microphone is installed in the ear impression 90L (S4). This step will be described in detail with reference to FIGS. 5 and 6. FIGS. 5 and 6 are cross-sectional views schematically showing the ear impression 90L. In FIGS. 5 and 6, the lateral direction is the thickness direction of the ear impression 90L, and the left side is the inner ear side. Here, an example in which the ear canal part 93 is formed in S3 without penetrating the base part 91 will be described. Specifically, as shown in FIG. 5, an end surface 93a of the ear canal part 93 is present midway in the thickness direction of the base part 91. The end surface 93a corresponds to the position of the stopper 82 of the shaped object 80L.

The ear canal part 93 includes a first curve part 93c and a second curve part 93d. The first curve part 93c and the second curve part 93d correspond to the first curve part 84 and the second curve part 85 shown in FIGS. 2 and 3, respectively. That is, the ear canal part 93 is curved along the user's ear canal.

A through hole 93b reaching the end surface 93a from the back surface 91b of the base part 91 is formed in the base part 91. Then, as shown in FIG. 6, the ear canal part 93 can be penetrated to the back surface 91b. The ear impression 90L can be provided with the ear canal part 93 extending from the front surface 91a to the back surface 91b. Specifically, by processing the base part 91, the through hole 93b reaching the ear canal part 93 can be formed in the base part 91. The base part 91 may be machined using a drill or the like or machined with a laser beam, etc.

For example, assuming that the thickness of the base part 91 is 4 cm, the through hole 93b of about 1 cm is provided. Thus, the ear canal part 93 penetrating to the back surface 91b side of the base part 91, namely, the ear canal part 93 penetrating to the inner ear side, can be formed. When the ear canal part 93 penetrating to the back surface 91b is formed at the time of shaping the ear impression 90L, the formation of the through hole 93b can be omitted.

It is preferable that the shape of the through hole 93b in the cross section perpendicular to the thickness direction (hereinafter, the shape in the cross section is referred to as a cross-sectional shape) be the same as the cross-sectional shape of the ear canal part 93. For example, the ear canal part 93 has an elliptical cross-sectional shape. More specifically, a human eardrum has an elliptical shape having a major axis (height) of about 9 mm and a minor axis (width) of about 8 mm. Therefore, it is preferable that the through hole 93b have an elliptical shape with a major axis and a minor axis of about 8 to 10 mm. The through hole 93b may be a straight canal parallel to the thickness direction. That is, the through hole 93b may be an elliptical cylinder having a constant cross section.

As shown in FIG. 6, the ear canal part 93 has a straight canal part 93e reaching the back surface 91b. The straight canal part 93e is formed to be straight along the thickness direction. The size (length) of the straight canal part 93e in the thickness direction is preferably 1 cm or more. The straight canal part 93e extends linearly to 1 cm or more from the back surface 91b of the ear impression 90L on the inner ear side. The ear impression 90L is formed of an integral resin material having the first curve part 93c, the second curve part 93d, and the straight canal part 93e.

As shown in FIG. 6, a microphone 60 is placed in the ear canal part 93 from the back surface 91b side. The microphone 60 is placed inside the ear canal part 93. In FIG. 6, the microphone 60 is placed in contact with the back surface 91b, and instead may be disposed closer to the front surface 91a side than the back surface 91b. The microphone 60 is placed closer to the back surface 91b side than the second curve part 93d in the ear canal part 93. Thus, the microphone 60 is preferably placed in the straight canal part 93e. The size of the microphone 60 is smaller than the diameter of the straight canal part 93e. Further, by setting the length of the straight canal part 93e to 1 cm, the microphone 60 can be installed at an appropriate position.

As described above, since the ear canal part 93 penetrating to the back surface 91b is formed in the ear impression 90L, the microphone 60 can be installed and adjusted from the back surface 91b side. Hence, the microphone 60 can be installed at an appropriate position. The use of the ear impression 90L including the ear canal part 93 facilitates an adjustment of the position of the microphone 60. For example, the microphone 60 can be placed so that the sound pickup direction thereof faces the entrance of the ear canal part. That is, the microphone 60 is placed in such a way that a diaphragm of the microphone 60 is placed along a plane perpendicular to the thickness direction. The microphone 60 smaller than the diameter of the ear canal part 93 enables a measurement without blocking the ear canal part 93.

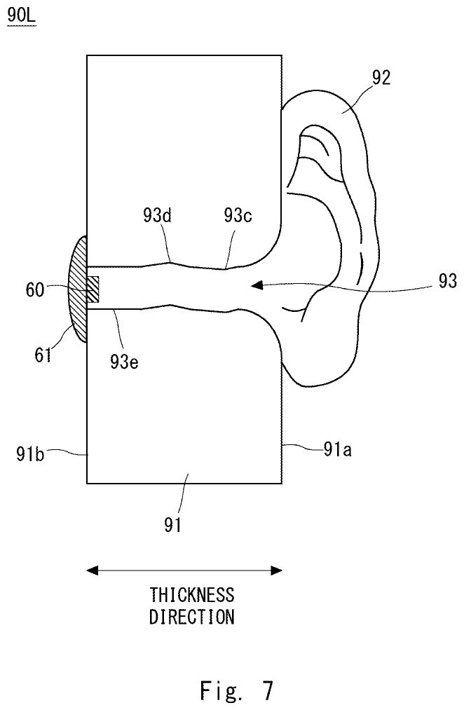

The microphone 60 may be fixed to the ear impression 90L by using an adhesive or the like. Alternatively, as shown in FIG. 7, the microphone 60 may be fixed to the ear impression 90L by blocking the opening of the ear canal part 93 on the back surface 91b side with a blocking member 61. A resin is used as the blocking member 61. In this case, by placing the blocking member 61 at or near the position of the eardrum, the shape of the ear canal part 93 can be made close to the shape of the user's ear canal.

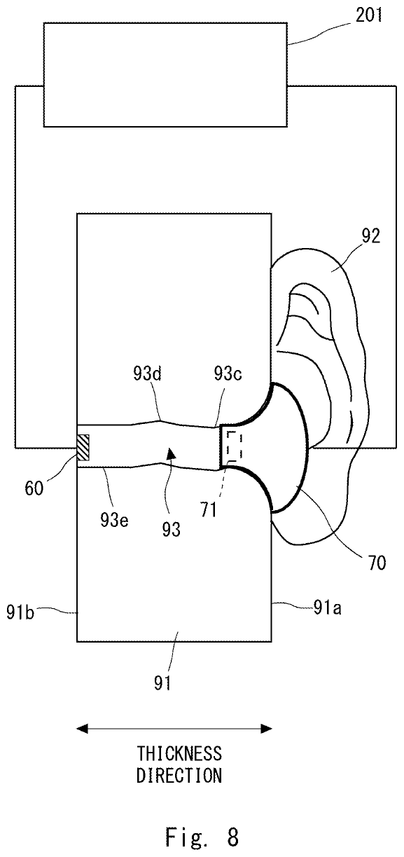

An earphone 70 is attached to the ear impression 90L, and the ECTF is measured (S5). FIG. 8 shows a state in which the earphone 70 is attached. The earphone 70 includes a driver unit 71 placed facing the inner ear side of the ear canal part 93. The driver unit 71 is placed facing the inner ear side of the ear canal part 93.

The earphone 70 may be a custom earphone produced in Step S3. The earphone 70 can be attached to the ear impression 90L at an appropriate position and angle. A general-purpose earphone other than a custom earphone may be used as the earphone 70, as a matter of course. In this case, Step S3 may be omitted. Alternatively, a headphone may be attached to the ear impression 90L in place of the earphone. When headphones are used, in order to recreate the side pressure of the headphones, it is preferable that the distance between the ear impression 90L and the ear impression 90R be the distance between the user's left and right ears, namely, the width of the user's head.

The earphone 70 and the microphone 60 are connected to a processing device 201. The processing device 201 is a user terminal such as a personal computer, a smartphone, or a tablet PC. The user terminal is an information processing device including processing means such as a processor, storage means such as a memory and a hard disk, display means such as a liquid crystal monitor, and input means such as a touch panel, buttons, a keyboard, and a mouse. The user terminal may have a communication function for transmitting and receiving data. Further, the processing device 201 is connected to the earphone 70 and the microphone 60 in a wired or wireless manner. The processing device 201 is not limited to a single physical apparatus, and instead a part of processing may be performed in a different device. For example, a part of processing may be performed by a personal computer or the like, and the rest of processing may be performed by a DSP (Digital Signal Processor) included in the earphone 70 or the like.

The processing device 201 generates a measurement signal and outputs it to the earphone 70. The processing device 201 generates an impulse signal, a TSP (Time Stretched Pulse) signal or the like as the measurement signal for measuring the transfer characteristics. The measurement signal includes a measurement sound such as an impulse sound. The processing device 201 acquires a sound pickup signal collected by the microphone 60. The processing device 201 includes a memory or the like for storing measurement data of the transfer characteristics. In this manner, the processing device 201 can measure the ECTF.

The processing device 201 generates the inverse characteristics of the ECTF (S6). For example, the processing device 201 calculates the frequency amplitude characteristics and the frequency phase characteristics of the ECTF by performing the discrete Fourier transform. Further, the processing device 201 may calculate the frequency amplitude characteristics and the frequency phase characteristics not only by the discrete Fourier transform but also by means for converting a discrete signal into a frequency domain, such as the discrete cosine transform. The frequency power characteristics may be used instead of the frequency amplitude characteristics. Then, the processing device 201 generates frequency amplitude characteristics for canceling out the frequency amplitude characteristics of the ECTF as the inverse characteristics.

The processing device 201 adjusts the inverse characteristics (S7). For example, the inverse characteristics may be adjusted by increasing the amplitude level of the low frequency range. Alternatively, the user may adjust the inverse characteristics based on the auditory sensation when the user performs trial listening. The adjustment of the inverse characteristics may be omitted.

The processing device 201 generates an inverse filter (S8). The processing device 201 can generate the inverse filter using the inverse characteristics adjusted in S7 and the frequency phase characteristics obtained in S6. For example, the processing device 201 applies discrete Fourier transform to the inverse characteristics and the frequency phase characteristics to generate an inverse filter in a time domain. The processing device 201 may generate the inverse filter by means of transforming a discrete signal into a frequency domain, such as a discrete cosine transform, instead of a discrete Fourier transform. Since known methods may be used in Steps S6 to S8, detailed descriptions thereof are omitted.

In the above description, the process of generating the inverse filter for the left ear using the ear impression 90L of the left ear has been described. The ear impression of the right ear can also be produced in a manner similar to that of the left ear. Specifically, an inverse filter for the right ear can be generated using the ear impression of the right ear.

By using the ear impression 90L, the microphone 60 can be installed at an appropriate position and angle. In particular, since the ear canal part 93 penetrates to the back surface 91b side, the microphone 60 can be easily installed and adjusted. The ear impression 90L includes a resin material formed integrally. The resin material has the first curve part 93c, the second curve part 93d, and the straight canal part 93e.

The straight canal part 93e is provided in the base part 91 in such a way that the ear canal part 93 penetrates the back surface 91b of the base part 91. Thus, the ear canal part 93 having a length sufficient for measuring the ECTF can be formed. For example, the impression material 81 to become the shaped object 80L cannot be injected close to the eardrum. Without the straight canal part 93e, the ear canal part 93 may not be long enough for a measurement. By forming the through hole 93b in the ear impression 90L as in this embodiment, the ear canal part 93 is provided with the straight canal part 93e. The microphone can be placed at a distance of 1 cm or more from the end surface 93a corresponding to a leading end of the shaped object 80L. The straight canal part 93e does not have to be exactly linear, namely, an elliptical cylinder. For example, a part of the straight canal part 93e may be curved or bent.

### Second Embodiment

In a second embodiment, the configuration of the ear impression 90L is different from that according to the first embodiment. The configuration and the processing according to the second embodiment other than those regarding the ear impression 90L are the same as those according to the first embodiment, and thus the description thereof will be omitted.

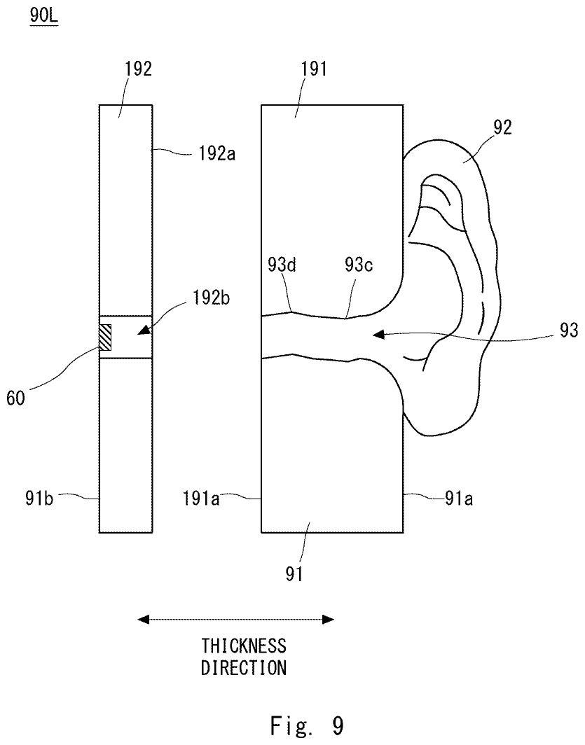

Specifically, as shown in FIG. 9, the ear impression 90L is divided into a first impression 191 and a second impression 192. That is, the second impression 192 is detachably provided to the first impression 191. As described in the first embodiment, the first impression 191 is produced based on the shaped object 80L. The first impression 191 includes the base part 91, the auricle part 92, and the ear canal part 93. The ear canal part 93 penetrates the first impression 191. Note that as in the first embodiment, the first impression 191 may be processed so that the ear canal part 93 penetrates the first impression 191.

The second impression 192 is a parallel resin plate and includes a through hole 192b. The through hole 192b corresponds to the through hole 93b and preferably has a length of 1 cm or more in the thickness direction. That is, the thickness of the second impression 192 is 1 cm or more. The through hole 192b is a straight elliptical cylinder. The microphone 60 is installed in the through hole 192b.

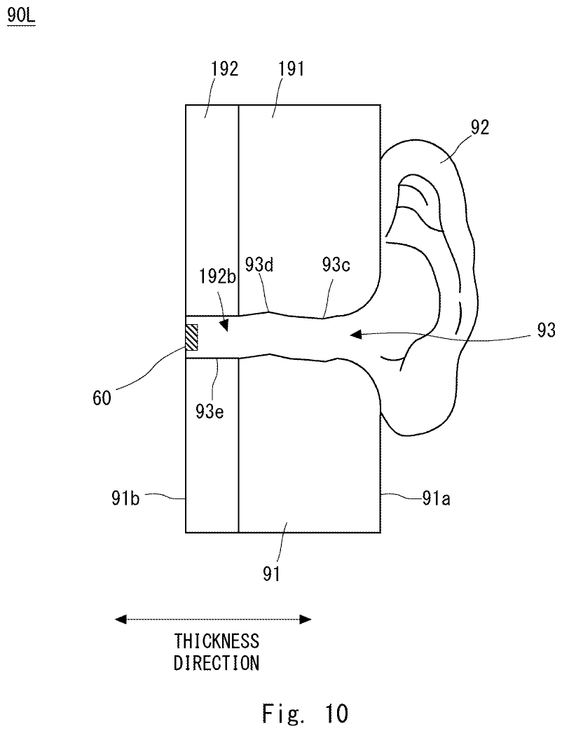

The surface of the first impression 191 on the inner ear side is used as a mounting surface 191a. The surface of the second impression 192 opposite to the inner ear side is used as a mounting surface 192a. The mounting surface 191a and the mounting surface 192a are planar. The second impression 192 is mounted on the first impression 191 so that the mounting surface 191a is brought into contact with the mounting surface 192a. Then, the through hole 192b is connected to the ear canal part 93 of the first impression 191, so that the integral ear canal part 93 as shown in FIG. 10 is formed.

That is, the ear canal part 93 extends from the front surface 91a of the first impression 191 to the back surface 91b of the second impression 192. By fixing the first impression 191 to the second impression 192 with an adhesive, an adhesive tape or the like, the same measurement as that in first embodiment can be performed.

According to this embodiment, the second impression 192 in which the microphone 60 is installed can be prepared in advance. That is, it is not necessary to install and adjust the microphone 60 for the first impression 191 produced for each user. Since the second impression 192 including the microphone 60 installed in advance may be attached to the first impression 191 produced for each user, the time taken for installation and adjustment can be shortened. Thus, the measurement can be easily performed.

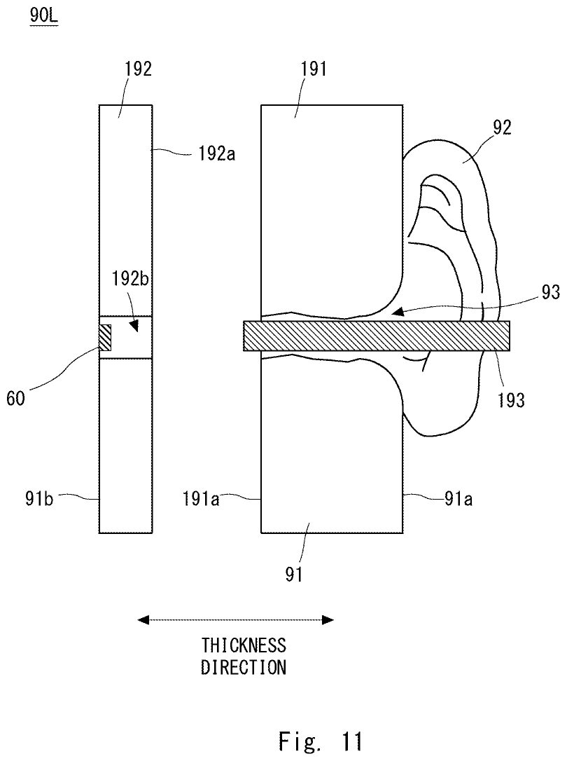

When the first impression 191 and the second impression 192 are connected, a positioning member and a form can be provided. For example, as shown in FIG. 11, a positioning member 193 may be used to align the through hole 192b with the ear canal part 93. Specifically, the bar-shaped positioning member 193 is inserted into the ear canal part 93 of the first impression 191. At this time, the positioning member 193 is placed so that a leading end of the positioning member 193 projects toward the second impression 192. The leading end of the positioning member 193 is placed in the through hole 192b. After the first impression 191 and the second impression 192 are fixed, the positioning member 193 is pulled out from the front surface 91a side. In this manner, the ear canal part 93 and the through hole 192b can be aligned.

The size of the ear canal may differ for each user. For example, the diameter of the cross-sectional shape of the ear canal varies depending on the user. Thus, a plurality of second impressions 192 having through holes 192b of different sizes may be prepared. For example, three second impressions 192 including large, medium, and small through holes 192b, respectively, are prepared. The second impression 192 including the large through hole 192b is attached to the first impression 191 produced for a user with a large size of an ear canal. The second impression 192 including the small through hole 192b is attached to the first impression 191 produced for a user with a small size of an ear canal. The second impression 192 including the medium through hole 192b is attached to the first impression 191 produced for a user with a standard size of an ear canal. By doing so, a more appropriate measurement can be performed.

Although the second impressions 192 including the through holes 192b of three sizes are prepared in the above description, the number of second impressions 192 to be prepared may be two or more. The ear canal has an elliptical cross-sectional shape. Thus, a plurality of through holes 192b having different aspect ratios may be prepared. The second impression 192 having the through hole 192b matching the size and shape of the ear canal part 93 of the first impression 191 may be used. In this manner, it is preferable to prepare a plurality of second impressions 192 and to form through holes 192b having different cross-sectional shapes or sizes.

Although the disclosure made by the present inventor has been described in detail based on the embodiments, the present disclosure is not limited to the embodiments described above, and various modifications can be made without departing from the scope of the present disclosure, as a matter of course.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A method of generating a filter comprising:
producing a shaped object to correspond to a user's ear canal using an impression material;
producing the user's ear impression based on the shaped object;
installing a microphone in an ear canal part penetrating to an inner ear side of the ear impression;
installing an earphone or a headphone in the ear impression;
measuring transfer characteristics by the microphone collecting a measurement signal output from the earphone or the headphone; and
generating a filter based on the transfer characteristics.

2. The method according to claim 1, further comprising:
producing a custom earphone corresponding to a shape of the user's ear using the ear impression, wherein
in the installing of the earphone or the headphone, the custom earphone is installed.

3. The method according to claim 1, wherein
the ear canal part includes a first curve part corresponding to a first curve of the user's ear canal and a second curve part corresponding to a second curve of the user's ear canal, and
the ear canal part includes a straight canal part extending from a back surface of the ear impression on an inner ear side.

4. The method according to claim 3, wherein
the ear impression comprises:
a first impression including the first curve part and the second curve part; and
a second impression including the straight canal part and attached to the first impression.

5. The method according to claim 3, wherein
in the producing of the ear impression, the ear impression is processed so that a through hole reaching the ear canal part from a back surface side of the ear impression is formed to thereby form the straight canal part.

6. The method according to claim 1, wherein
a blocking member for blocking an opening of the ear canal part on an inner ear side is provided.

7. A sound pickup device comprising:
an ear impression produced to correspond to a shape of a user's ear; and
a microphone installed in an ear canal part penetrating the ear impression.

8. The sound pickup device according to claim 7, wherein
the ear canal part includes a first curve part corresponding to a first curve of the user's ear canal and a second curve part corresponding to a second curve of the user's ear canal, and
the ear canal part includes a straight canal part extending from a back surface of the ear impression on an inner ear side.

9. The sound pickup device according to claim 8, wherein
the ear impression is formed of an integral resin material including the first curve part, the second curve part, and the straight canal part.

10. The sound pickup device according to claim 8, wherein
the ear impression comprises:
a first impression including the first curve part and the second curve part; and
a second impression including the straight canal part and attached to the first impression.

11. A filter generation device comprising:
the sound pickup device according to claim 7; and
a processing device configured to output a measurement signal to an earphone or a headphone installed in the ear impression and generate a filter based on a measurement signal collected by the microphone.
